(19) United States
(12) Patent Application Publication
(10) Pub. No.: US 2004/0081146 A1
(43) Pub. Date: Apr. 29, 2004

(54) Cross-point switch with equalized inputs

(76) Inventors: Benjamim Tang, Rancho Palos Verdes, CA (US); James M. Anderson, Huntington Beach, CA (US)

Correspondence Address: MCANDREWS HELD & MALLOY, LTD, 500 WEST MADISON STREET, SUITE 3400, CHICAGO, IL, 60661

(21) Appl. No.: 10/278,544

(22) Filed: Oct. 23, 2002

(51) Int. Cl. H04L 12/50

(52) U.S. Cl. 370/370

(57) ABSTRACT

A cross-point switch includes at least one signal input port and a signal equalizer connected to the signal input port. The signal equalizer compensates for low pass attenuation effects on an input signal present at the signal input port. The cross-point switch also includes a switch fabric connected to the signal equalizer, and at least one switch output port coupled to the switch fabric. An address controller and switch fabric control bus may be used to control the mapping of input ports to output ports. Each input port may optionally be connected to a set of signal equalizers. A multiplexer may be connected to each of the signal equalizers for connecting one signal equalizer output through a multiplexer output to the switch fabric.

### CROSS-REFERENCE TO RELATED APPLICATIONS

This Application is related to Ser. No. 09/261,043, filed Mar. 2, 1999 and titled “Monolithic Fixed Active Equalizer”.

### BACKGROUND OF THE INVENTION

Cross-point switches are critical elements in modern communication networks. In general, a cross-point switch allows a signal present at any of N input ports to be redirected to any of M output ports. As a result, a cross-point switch provides a sophisticated routing function underlying data flow through advanced communication networks.

The performance of a cross-point switch, however, is limited by the quality of the signal present on its inputs and the effect of the cross-point switch itself on the signal as it traverses the switch. In particular, the design and construction of prior cross-point switches placed certain limits on the data rate of signals that could reliably traverse the core switch fabric in the cross-point switch. Thus, for example, the parasitic effects of buffers, multiplexers, and signal traces inside the switch were often data rate limiting factors, particularly with input signals already attenuated by transmission through long coaxial connections.

However, driven in part by established optical networking technologies, data rates and signal frequency are ever increasing. Networks that can meet the potentially available data rates will benefit through increased throughput and, ultimately, increased revenue. However, as noted above, past cross-point switches were unduly limited in the data rate of signals that could traverse the cross-point switch.

A need has long existed in the industry for a cross-point switch that addresses the problems noted above and others previously experienced.

### BRIEF SUMMARY OF THE INVENTION

A preferred embodiment of the invention provides a cross-point switch. The cross-point switch includes at least one signal input port and a signal equalizer connected to the signal input port. The signal equalizer compensates for low pass attenuation effects on an input signal present at the signal input port. The cross-point switch also includes a switch fabric connected to the signal equalizer, and at least one switch output port coupled to the switch fabric. An address controller and switch fabric control bus may be used to control the mapping of input ports to output ports.

Each input may optionally be connected to a set of signal equalizers, each designed to provide signal compensation at specific frequencies, data rates, and the like. Thus, for example, the signal input port may be connected to four signal equalizers providing individually tailored response according to a range of expected input signal frequencies. A multiplexer may be connected to each of the signal equalizers for connecting one signal equalizer output through a multiplexer output to the switch fabric. To that end, the address controller may also drive a multiplexer input selection control to select a particular signal equalizer output.

### BRIEF DESCRIPTION OF THE DRAWINGS

FIG. 1 illustrates a cross-point switch.

FIG. 2 shows an implementation of a signal equalizer.

FIGS. 3-5 depict processing steps that may be used to construct a signal equalizer.

FIG. 6 shows a method for communicating signals through a cross-point switch.

### DETAILED DESCRIPTION OF THE INVENTION

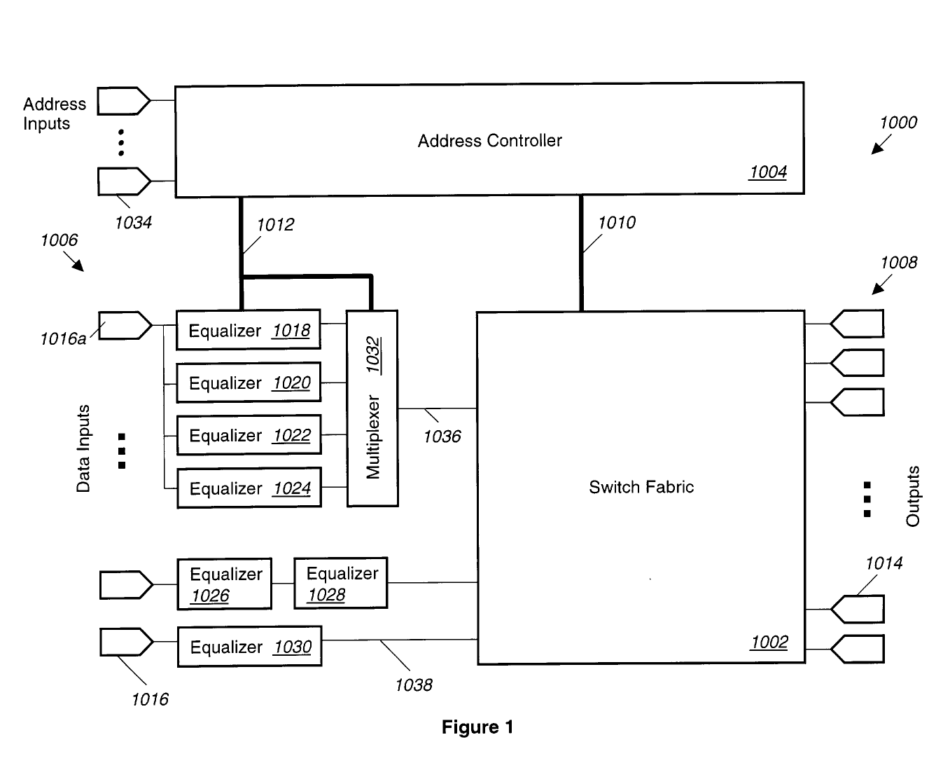

Turning now to FIG. 1., that figure illustrates a cross-point switch 1000. The cross-point switch 1000 includes a switch fabric 1002, an address controller 1004, an input section 1006 and an output section 1008. A switch fabric control bus 1010 connects the address controller 1004 to the switch fabric 1002, while the equalizer control bus 1012 connects the address controller 1004 to circuitry in the input section 1006.

The output section 1008 generally includes numerous signal output ports (e.g., the signal output port 1014). The input section 1006 generally includes numerous signal input ports (e.g., the signal input port 1016) and signal equalizers (e.g., the signal equalizers 1018, 1020, 1022, 1024, 1026, 1028, and 1030). As will be explained in more detail below, the input section 1006 may also include multiplexers (e.g., the multiplexer 1032) for selecting between multiple signal equalizers. In response to the address inputs 1034, the address controller 1004 outputs control signals on the switch fabric control bus to connect a signal from an input port to an output port, and also outputs control signals, if required, on the equalizer control bus 1012 to configure or adapt signal equalizers for expected input signals as well as control multiplexer operation.

In general, the cross-point switch 1000 implements an N×M switch. As specific examples, the switch fabric 1002 may implement, using conventional switch fabric construction, a 32×32, 64×64, or 128×128 switch. Other values of N and M are also suitable, however.

With specific reference again to the input section 1006, each input port is preferably provided with a signal equalizer. Each signal equalizer compensates for low pass attenuation of input signals, for example, by boosting high frequency content in the input signals present on the input ports. Each signal equalizer may be individually tailored (according to the detailed signal equalizer design discussed below) to address expected input signal characteristics such as data rate, frequency, attenuation, and the like.

Thus, for example, the signal input port 1016a is connected to the signal equalizers 1018-1024. The multiplexer 1032 may then select one of the signal equalizer 1018-1024 outputs to be coupled to the switch fabric 1002 on the multiplexer output 1036. To that end, the equalizer control bus 1012 may include one or more signal lines that form a multiplexer input selection control for selecting the output signal from one of the signal equalizers 1018-1024. The address controller 1004 is generally constructed as address decoding logic that maps input ports to output ports (and that asserts the multiplexer input selection control, if necessary) in accordance with signals present on the address inputs 1034.

It is not required that multiple signal equalizers and a multiplexer be connected to each signal input. Rather, a signal input may use a single signal equalizer (e.g., the signal equalizer 1030 and associated compensated signal output 1038) for all input signals. Alternatively, one or more signal equalizers (e.g., the signal equalizers 1026 and 1028) may be cascaded for greater compensation, with an optional intermediate buffer stage. Furthermore, in certain embodiments, one or more of the signal equalizers may be replaced with an adaptive equalizer that adjusts to input signal characteristics automatically (i.e., without the need for control or selection through the equalizer control bus 1012), or with a programmable equalizer that has resistance, capacitance, or inductance electrically adjusted by signals on the equalizer control bus 1012 to match expected signal input characteristics.

The signal equalizers compensate for signal attenuation caused by transmission lines such as coaxial cable or traces on a printed circuit board (PCB). Increased transmission line length and higher data rates are therefore attainable. Each signal equalizer is preferably formed as an active lead lag filter from bipolar technology, such as heterojunction bipolar transistor (HBT) technology, that enables the signal equalizer to be fabricated monolithically as well as integrated with other components. The signal equalizer is adapted to operate at relatively high frequencies (e.g., 10 GHz or more) while consuming only nominal amounts of power and chip area.

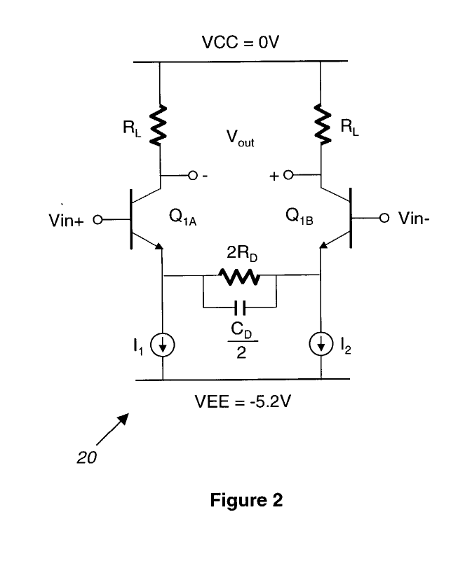

The signal equalizer architecture is illustrated in FIG. 2 and generally identified with the reference numeral 20. The signal equalizer 20 may be formed, as examples, from GaAs heterojunction bipolar transistor (HBT) technology, or silicon based bipolar junction transistor (BJT) technology. As will be evident from the discussion below, the signal equalizers are adapted to function on differential input signals.

Referring to FIG. 2, the signal equalizer 20 includes a pair of differentially connected transistors Q1A and Q1B. The differentially connected transistors Q1A and Q1B are connected in a common emitter configuration. The base terminals of each of the transistors Q1A and Q1B form bipolar input terminals Vᵢₙ₊ and Vᵢₙ₋. An emitter degeneration resistor 2R_{D} is connected between the emitter terminals of the differentially connected transistors Q1A and Q1B. A shunt capacitance C_{D}/2 is connected in parallel across the degeneration resistor 2R_{D}. The emitters of the differentially connected transistors Q1A and Q1B are each connected to a current source I₁ and I₂ which in turn, are connected to a common voltage source VEE. The collector terminals of the differentially connected transistors Q1A and Q1B are each connected to a load resistor R_{L}, which, in turn are connected to a supply voltage source VCC. The output Vₒᵤₜ of the signal equalizer 20 is available across the collector terminals of the differentially connected transistors Q1A and Q1B.

The transfer function of the signal equalizer 20 in the S domain is illustrated in equation 1 below:

$$\frac{{V}_{out} ( S )}{{V}_{i n} ( S )} = \frac{{g}_{m} {R}_{L } ( S + \frac{1}{{R}_{D} {C}_{D}} )}{S + \frac{1 + {g}_{m} {R}_{D}}{{R}_{D} {C}_{D}}}$$

The transfer function has a zero at ½ π R_{D} C_{D}. For a fixed value of the emitter degeneration resistor R_{D}, varying the shunt capacitance C_{D} results in an increase in a high frequency boost. Parasitic capacitance on the output node creates a second high frequency pole with the load resistor R_{L} which rolls off the high frequency response. Due to the low complexity of the equalizer design and its accompanying transfer function, the signal equalizer 20 can be designed to operate at relatively high frequencies while consuming only nominal amounts of power and chip area.

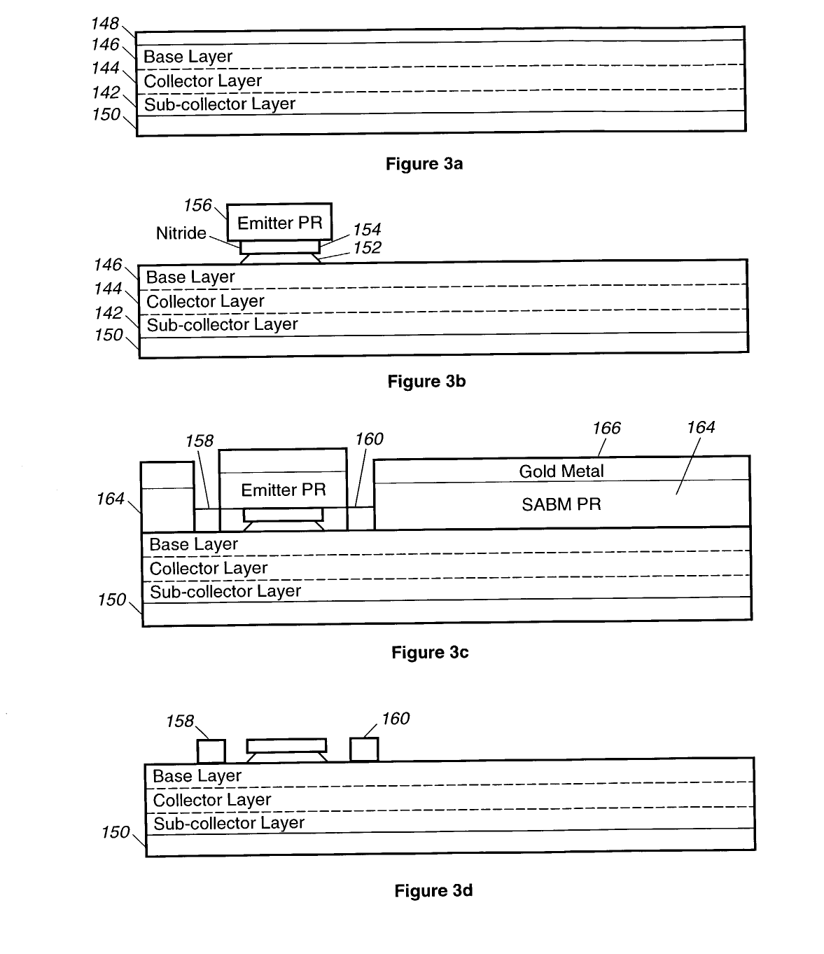

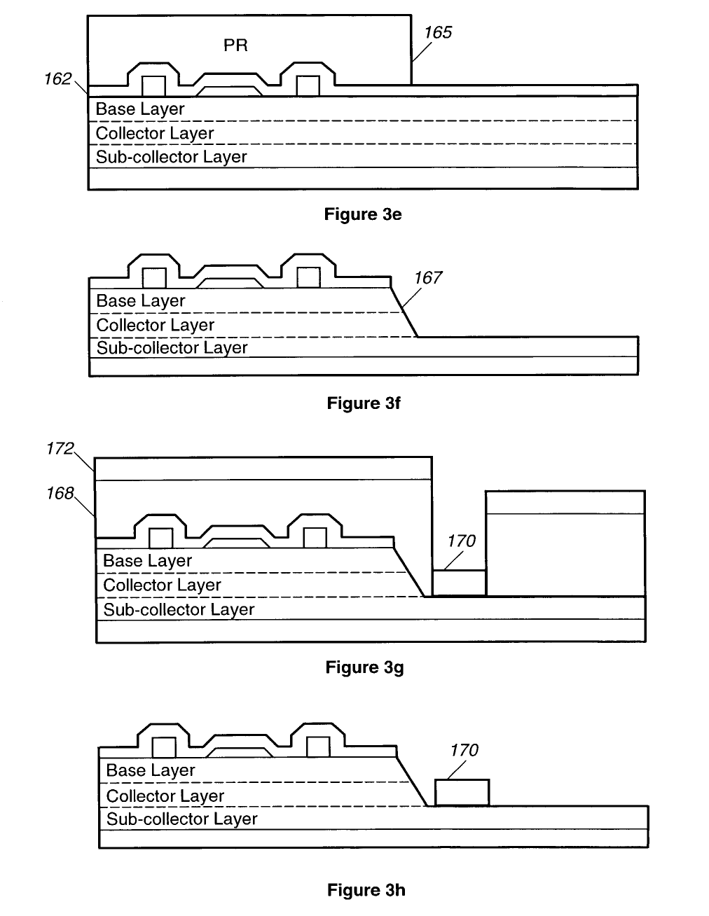

The process steps for forming a signal equalizer in accordance with the present invention, for example from GaAs technology, are illustrated in FIGS. 3a-3h, 4a-4f and 5a-5c and described below. Initially, a GaAs wafer (not shown) is obtained for use as a substrate. An alignment key structure is placed on the wafer in a known manner prior to processing. Referring to FIG. 3a, a vertical stack of semiconductor layers for example, a sub-collector layer 142, a collector layer 144, a base layer 146 and an emitter layer 148 are grown on top of substrate layer 150 (FIG. 3a), for example, by molecular beam epitaxy (MBE). Subsequently, as illustrated in FIG. 3b, an emitter mesa 152 with a nitride layer 154 is formed by conventional photolithography techniques and etched. In particular, the emitter mesa 152 may be formed by wet chemical etching techniques to form the undercuts as shown relative to the nitride layer 154. The nitride is etched by dry etching techniques. An emitter photoresist 156 is spun on top of the structure and developed with a slight overhang as shown in FIG. 3b. As discussed in more detail below, the emitter photoresist layer 156 is used in part to provide automatic spacing of the base ohmic contacts 158 and 160 as shown in FIG. 3c. An additional layer of photoresist 164 is spun off the device as shown in FIG. 3c. The photoresist, for example, self-aligned base metal (SABM), is developed by conventional techniques and in cooperation with the emitter photoresist layer 156 determines the location of the base ohmic metal contacts 158 and 160. After the SABM photoresist layer 164 is developed and exposed, the base metal ohmic contacts is deposited on the structure. The excess metal layer 166 and photoresist 164 are lifted off by conventional techniques as illustrated in FIG. 3d, leaving the base ohmic metal contacts 158 and 160.

Subsequently, as shown in FIG. 3e, the nitride layer 154 is etched completely off the emitter mesa 152. Subsequently, a second nitride layer 162 is deposited on the device. In preparation of the formation of non-ohmic contacts as discussed below, a photoresist 165 is spun onto the device in preparation for formation of the collector ohmic metal contacts, as generally shown in FIG. 3e. As shown, FIG. 3f, the photoresist layer 165 is exposed and developed in a conventional manner in preparation of a base mesa etch. In particular, as shown in FIG. 3f, the second nitride layer 162 is etched followed by etching of the base layer 146 and collector layer 144 to form a base mesa 167. The photoresist 165 is then stripped by conventional techniques resulting in the structure illustrated in FIG. 3f.

Another photoresist layer 168 is spun onto the device as shown in FIG. 3g. The photoresist layer 168 is patterned and developed to locate the collector ohmic contact 170. A collector ohmic metal layer 172 is deposited on the device and lifted off by conventional techniques as shown in FIG. 3h to form the collector ohmic metal contact 170.

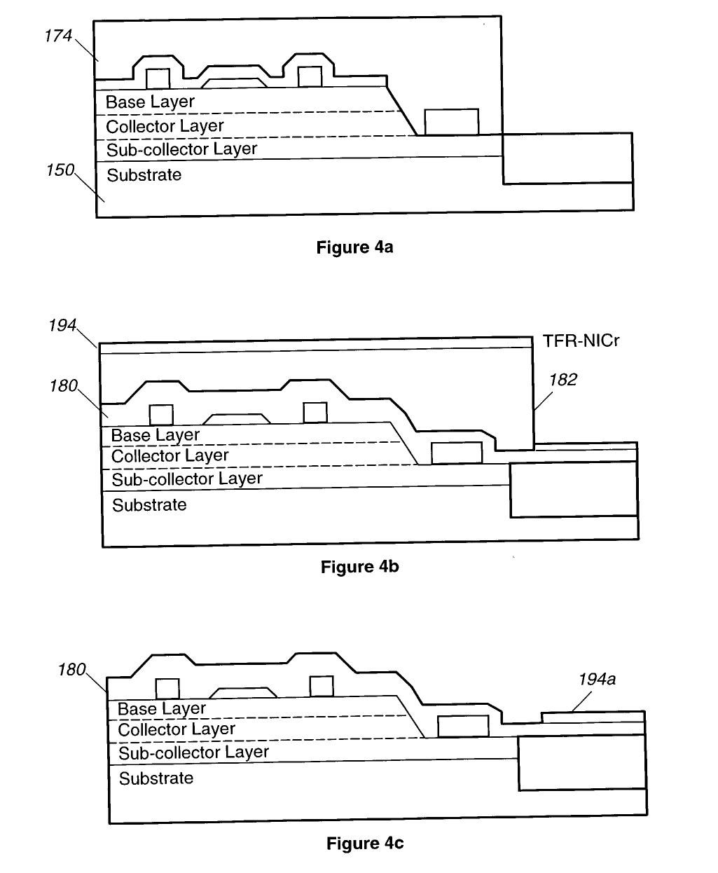

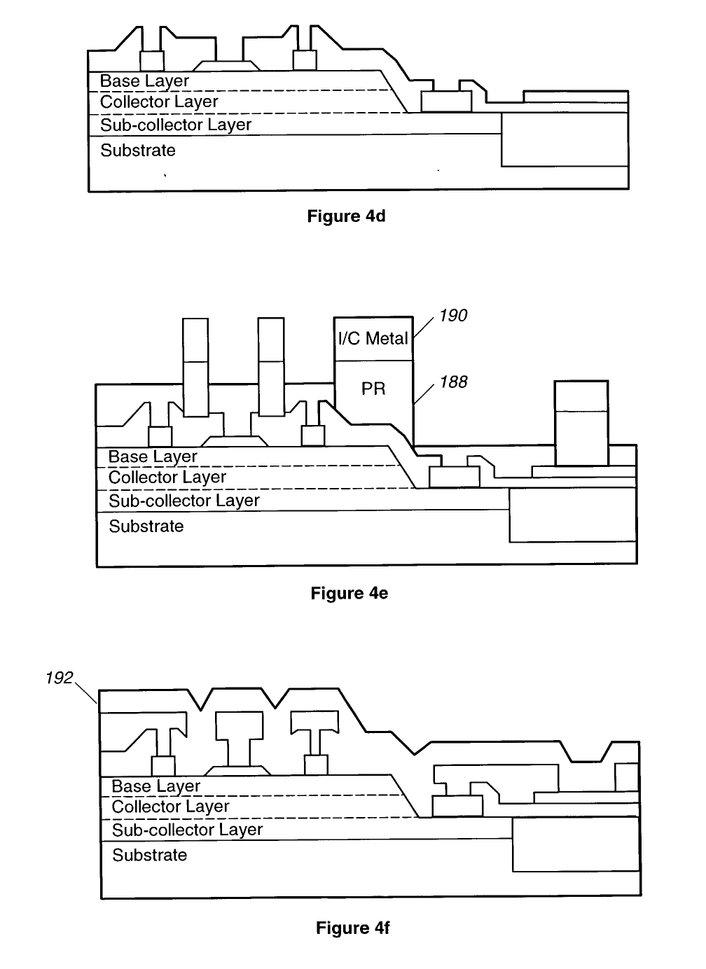

Next, isolation regions are formed in the device. These isolation regions formed by way of a photoresist layer 174 which is spun onto the device. The photoresist 174 is patterned and exposed as shown in FIG. 4a. Boron ions, for example, are implanted into the device to form the isolation regions. A thin film resistor may optionally be formed on the device. The thin film resistor may be formed by stripping the photoresist layer 174 applied in FIG. 4a and depositing another silicon nitride layer 180. After the silicon nitride layer 180 is deposited on the device, another photoresist layer 182 is spun on the device as illustrated in FIG. 4b. The photoresist layer 182 may be used to define the location of the thin film resistor 194a. The thin film resistor may be formed by depositing a CERMET film 194, for example (CrSIO), on top of the device is generally shown in FIG. 4b. The excess metal and photoresist are removed by conventional techniques as shown in FIG. 4c, leaving the thin film resistor 194a and the structure as shown in FIG. 4c.

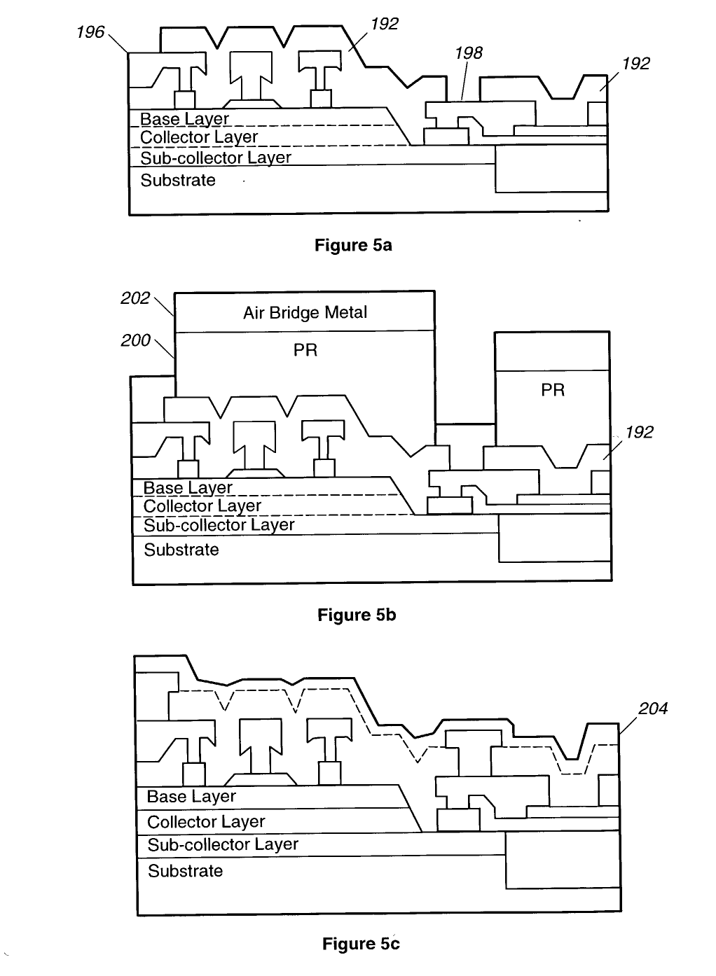

Another photoresist (not shown) is spun on top of the device to define the locations of the interconnect metal. The nitride layer 180 is etched as shown in FIG. 4d. A photoresist 188 is applied to the device as shown in FIG. 4e and patterned to define the interconnect metals. The photoresist 188 is developed in a conventional matter in a layer of interconnect metal 190, for example Ti/Pt/Au/Ti, is deposited on the device as generally shown in FIG. 4e. The excess metal and photoresist layer 188 are lifted off by conventional techniques. Subsequently, a fourth nitride layer 192 is deposited as shown in FIG. 4f. As shown in FIG. 5a, vias 196 and 198 are formed in the interconnect metal layer. These vias 196 and 198 are formed by spinning a photoresist on top of the device; patterning the photoresist with conventional techniques to define the vias 196 and 198; developing the photoresist and subsequently etching the nitride layer 192 to form the vias 196 and 198, as generally shown in FIG. 5a. Next, as shown in FIG. 5b, an air bridge is formed. The air bridge is formed by spinning a photoresist 200 on top of the device and patterning the photoresist to form an air bridge. A metal layer 202 is then deposited on top of the photoresist 200 to form the air bridge. The photoresist is then removed by conventional techniques. A passivation nitride layer 204 may be deposited on the device as shown in FIG. 5c. A photoresist may be used to form the dice streets to enable the chips to be diced.

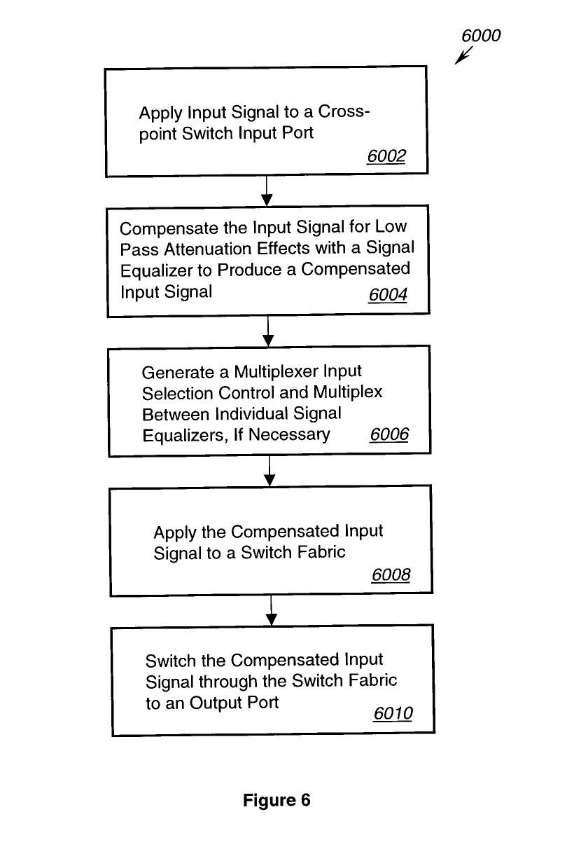

Referring next to FIG. 6, a method 6000 for switching signals through a cross-point switch is summarized. The method includes applying (6002) an input signal to a cross-point switch input port and compensating (6004) the input signal for low pass attenuation effects. A compensated input signal is thereby produced.

The method next generates (6006), if necessary, a multiplexer input selection control and multiplexes between individual signal equalizes connected to a single input port. Subsequently, the method applies (6008) the compensated input signal to a switch fabric, and switches (6010) the compensated input signal through the switch fabric to an output port.

The signal equalizers present in the input section 1006 provide signal compensation that allows the cross-point switch to operate with (e.g., 5-10 Gbps) higher frequency signals that arrive even in poor condition at the switch input ports. As a result, the cross-point switch 1000 extends the data rates and frequencies at which data may be transported through sophisticated communication networks.

While the invention has been described with reference to one or more preferred embodiments, those skilled in the art will understand that changes may be made and equivalents may be substituted without departing from the scope of the invention. In addition, many modifications may be made to adapt a particular step, structure, or material to the teachings of the invention without departing from its scope. Therefore, it is intended that the invention not be limited to the particular embodiment disclosed, but that the invention will include all embodiments falling within the scope of the appended claims.

What is claimed is:

1. A cross-point switch comprising:
a signal input port;
a signal equalizer connected to the signal input port for compensating for low pass attenuation effects on an input signal present at the signal input port;
a switch fabric connected to the signal equalizer; and
a switch output port coupled to the switch fabric.

2. A cross-point switch as claimed in claim 1, further comprising a switch fabric control bus connected to the switch fabric.

3. A cross-point switch as claimed in claim 2, further comprising an address controller connected to the switch fabric control bus.

4. A cross-point switch as claimed in claim 1, wherein the signal equalizer is one of a plurality of signal equalizers, each connected to the signal input port.

5. A cross-point switch as claimed in claim 4, further comprising a multiplexer connected to each signal equalizer of the plurality of signal equalizers.

6. A cross-point switch as claimed in claim 5, further comprising a multiplexer output connected to the switch fabric and a multiplexer input selection control connected to the multiplexer.

7. A cross-point switch as claimed in claim 1, further comprising at least one additional signal input port connected to the switch fabric through at least one additional signal equalizer.

8. A cross-point switch as claimed in claim 1, further comprising at least one additional output port coupled to the switch fabric.

9. A cross-point switch comprising:
a signal input port;
a signal equalizer comprising differentially connected transistors connected to the signal input port for compensating for low pass attenuation effects on an input signal present at the signal input port;
a switch fabric connected to the signal equalizer; and
a switch output port coupled to the switch fabric.

10. A cross-point switch comprising:
a signal input port;
a signal equalizer comprising differentially connected transistors connected in a common emitter configuration, each of the differentially connected transistors including a base, collector, and emitter terminal connected to the signal input port for compensating for low pass attenuation effects on an input signal present at the signal input port;
a switch fabric connected to the signal equalizer; and
a switch output port coupled to the switch fabric.

11. A cross-point switch as claimed in claim 10, wherein at least one of the collector terminals is connected to a supply voltage through a load resistor, and wherein at least one of the emitter terminals is connected to a common voltage through a current source.

12. A method for switching signals through a cross-point switch, the method comprising:
applying an input signal to a cross-point switch input port;
compensating the input signal for low pass attenuation effects to produce a compensated input signal;
applying the compensated input signal to a switch fabric; and
switching the compensated input signal through the switch fabric to an output port.

13. The method of claim 12, further comprising multiplexing between the plurality of individual signal equalizers.

14. An cross-point switch input section comprising:
a plurality of signal input ports including a first input port and a second input port;
a first signal equalizer connected to the first input port;
a second signal equalizer connected to the second input port;
a first compensated signal output for coupling a first compensated signal to a switch fabric; and
a second compensated signal output for coupling a second compensated signal to the switch fabric.

15. A cross-point switch signal input section according to claim 14, further comprising:
a third signal equalizer connected to the first input port; and
a multiplexer connected to the first and third signal equalizers, the multiplexer including a multiplexer output for connection to the switch fabric.

16. A cross-point switch signal input section according to claim 14, further comprising
a multiplexer input selection control connected to the multiplexer.

17. A cross-point switch signal input section according to claim 14, further comprising
a third signal equalizer cascaded with the first signal equalizer.

18. A cross-point switch signal input section according to claim 14, wherein the first signal equalizer comprises differentially connected transistors.

19. A cross-point switch input section comprising:
a plurality of signal input ports including a first input port and a second input port;
a first signal equalizer comprising differentially connected transistors connected in a common emitter configuration, each of the differentially connected transistors including a base, collector, and emitter terminal connect to the first input port;
a second signal equalizer connected to the second input port;
a first compensated signal output for coupling a first compensated signal to a switch fabric; and
a second compensated signal output for coupling a second compensated signal to the switch fabric.

20. A cross-point switch signal input section according to claim 19, wherein at least one of the collector terminals is connected to a supply voltage through a load resistor, and wherein at least one of the emitter terminals is connected to a common voltage through a current source.
